(19) United States
(12) Patent Application Publication
(10) Pub. No.: US 2017/0012456 A1
(43) Pub. Date: Jan. 12, 2017

(54) POWER SUPPLY DEVICE CAPABLE OF SUPPLYING MULTIPLE POWER SOURCES

(71) Applicant: COREMATE TECHNICAL CO., LTD., Taoyuan County (TW)

(72) Inventor: Robert Wang, TAOYUAN COUNTY (TW)

(21) Appl. No.: 14/796,588

(22) Filed: Jul. 10, 2015

(51) Int. Cl. H02J 7/02

(52) U.S. Cl. CPC H02J 7/025

(57) ABSTRACT

A power supply device capable of supplying multiple power sources includes a main body made of a soft material. A wireless charging module is provided inside the main body for supplying a wireless charging power source. The main body is connected with at least one USB power socket, a rod member and an electric cord. The rod member is further pivotally connected with a plurality of alternating current power sockets. By the USB power socket, the alternating current power sockets, and the main body, the power supply device can perform charging according to the demand of the user. By the material of the main body to cooperate with the rotatable alternating current power sockets, the present invention saves the space and is convenient for use and carrying so as to enhance the practicability and convenience of the power supply device.

### BACKGROUND OF THE INVENTION

1. Field of the Invention

The present invention relates to a power supply device, and more particularly to a power supply device capable of supplying multiple power sources.

2. Description of the Prior Art

In general, electronic devices or electrical products get power through an alternating current power socket or a USB socket. In addition, portable electrical products, such as smart phones, smart watches, smart bracelets, tablet PCs and the like, get power through a wireless charging panel for charging.

Although the aforesaid alternating current power socket, the USB socket and the wireless charging panel enable the electronic devices or electrical products to get the required power. However, the alternating current power socket, the USB socket and the wireless charging panel are separate. When in use, they must be taken out respectively. This occupies the space in use and is inconvenient for the user to take along. Accordingly, the inventor of the present invention has devoted himself based on his many years of practical experiences to solve these problems.

### SUMMARY OF THE INVENTION

The primary object of the present invention is to provide a power supply device capable of supplying multiple power sources in order to meet the demand of various charging ways. The present invention saves the space and is convenient for use and carrying so as to enhance the practicability and convenience of the power supply device.

In order to achieve the object, the power supply device capable of supplying multiple power sources of the present invention comprises a main body, at least one USB power socket, a rod member, a plurality of alternating current power sockets, and a power cord. The main body is a thin panel. A wireless charging module is provided inside the thin panel for supplying a wireless charging power source. The USB power socket is disposed at one side of the main body for supplying a direct current power source. The rod member is horizontally disposed at one side of the main body. The alternating current power sockets each are horizontally formed with a through hole corresponding to the rod member, enabling the alternating current power sockets to be pivotally connected with the rod member, for supplying an alternating current power source. The power cord is connected to one side of the main body.

By the USB power socket, the alternating current power sockets, and the main body, the power supply device capable of supplying multiple power sources of the present invention can perform charging according to the demand of the user. The alternating current power sockets can be turned to a position for convenient use relative to the rod member. The main body is made of a soft material which can be rolled conveniently. Accordingly, by combining the USB power socket and the alternating current power sockets with the main body as well as the material of the main body to cooperate with the rotatable alternating current power sockets, the present invention saves the space and is convenient for use and carrying so as to enhance the practicability and convenience of the power supply device.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is a schematic view according to the preferred embodiment of the present invention, showing that the alternating current power socket is turned the state for use;

FIG. 4 is a schematic view of the preferred embodiment of the present invention in a charging state;

FIG. 5 is a schematic view of the preferred embodiment of the present invention connected with a table lamp;

FIG. 6 is a sectional view according to the preferred embodiment of the present invention, showing that the alternating current power socket is turned to a state not in use;

FIG. 7 is a sectional view according to the preferred embodiment of the present invention, showing that the alternating current power socket is turned to a state for use.

### DETAILED DESCRIPTION OF THE PREFERRED EMBODIMENTS

Embodiments of the present invention will now be described, by way of example only, with reference to the accompanying drawings.

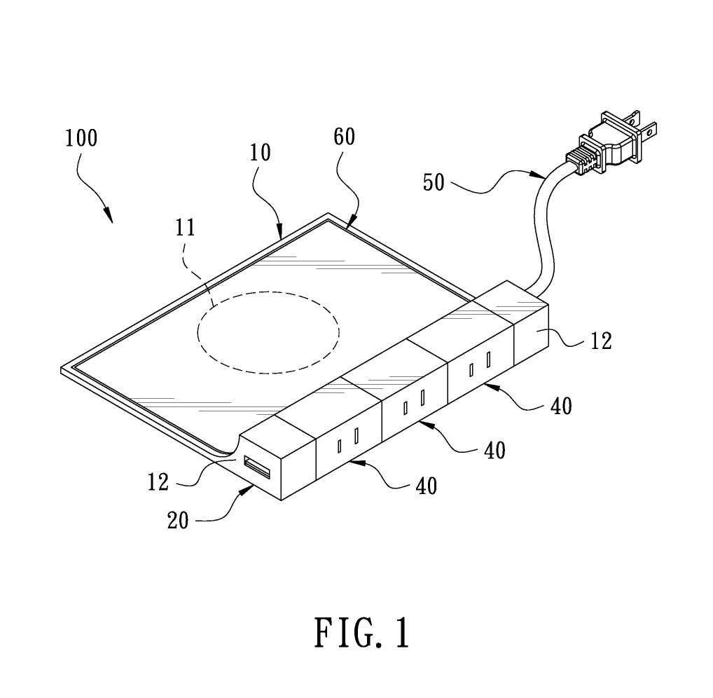

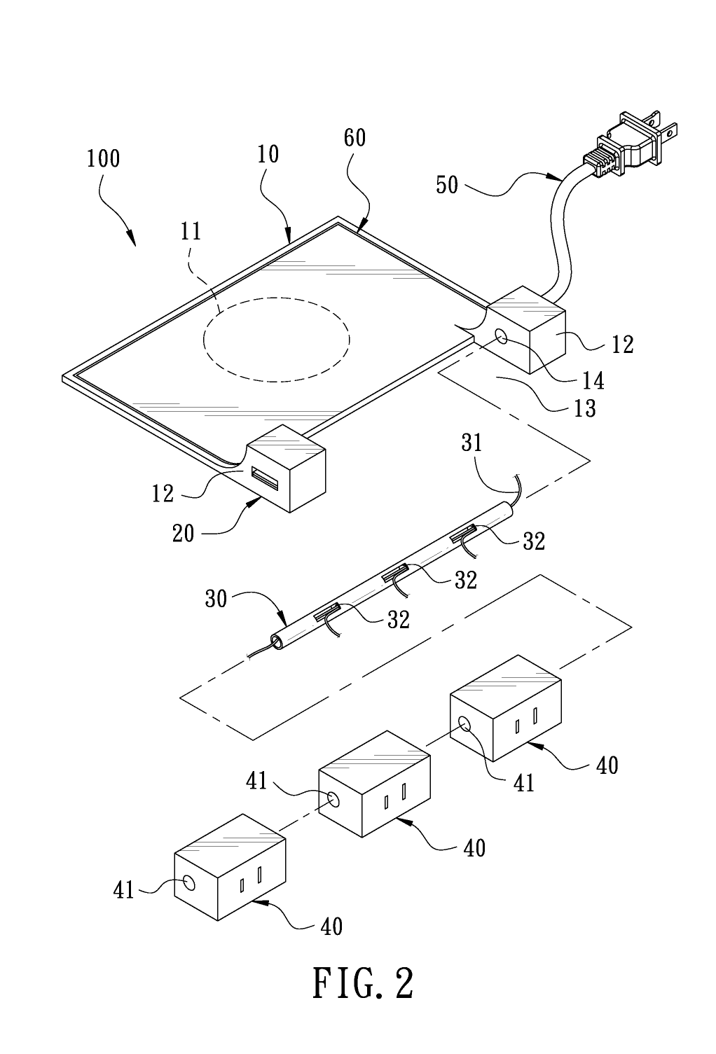

FIG. 1 is a perspective view according to a preferred embodiment of the present invention. FIG. 2 is an exploded view according to the preferred embodiment of the present invention. The present invention discloses a power supply device 100 capable of supplying multiple power sources. The power supply device capable of supplying multiple power sources comprises a main body 10, at least one USB power socket 20, a rod member 30, a plurality of alternating current power sockets 40, and a power cord 50.

The main body 10 is a thin panel made of a soft material. A wireless charging module 11 is provided inside the thin panel for supplying a wireless charging power source. In the preferred embodiment of the present invention, the main body 10 has a rectangular shape. Two ends of one side of the main body 10 extend outward to form support arms 12, respectively. The main body 13 is formed with a recess 13 defined between the two support arms 12. Inner sides of the support arms 12 are provided with insertion holes 14.

The USB power socket 20 is disposed at one side of the main body 10 for supplying a direct current power source.

The rod member 30 is horizontally disposed at one side of the main body 10.

In the preferred embodiment of the present invention, two ends of the rod member 30 are inserted into the insertion holes 14 of the support arms 12 respectively, such that the rod member 30 is located in the recess 13 of the main body 10. The rod member 30 is a circular hollow rod member for a plurality of electric wires 31 to be inserted therein. Furthermore, the rod member 30 is formed with a plurality of holes 32 which are arranged obliquely, outward and upward. The holes 32 each have a width about a quarter of the circumference of the rod member 30 for the electric wires 31 in the rod member 30 to pass therethrough.

Each alternating current power socket 40 is horizontally formed with a through hole 41 corresponding to the rod member 30, such that the alternating current power sockets 40 are pivotally connected with the rod member 30 for supplying an alternating current power source.

The power cord 50 is connected to one side of the main body 10.

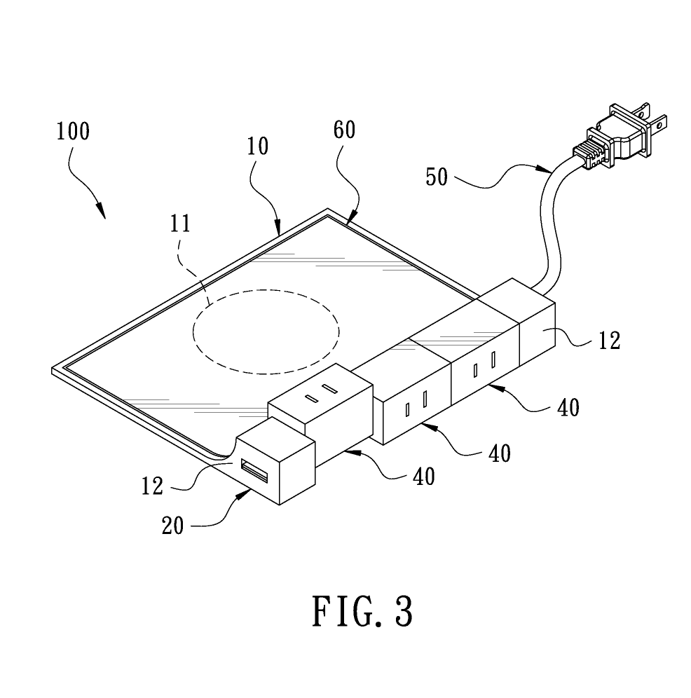

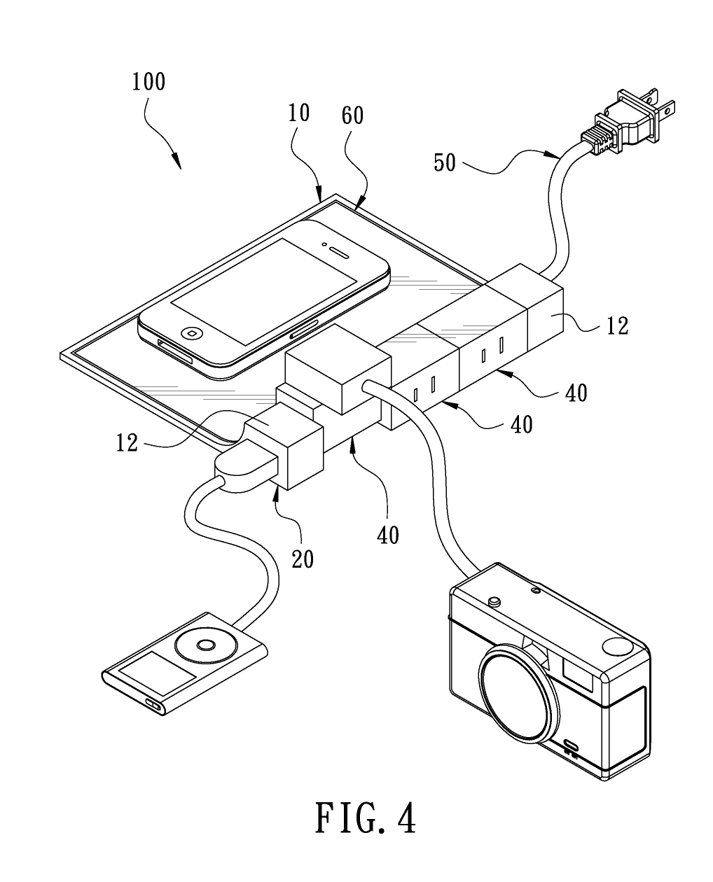

FIG. 3 is a schematic view according to the preferred embodiment of the present invention, showing that the alternating current power socket is turned the state for use. FIG. 4 is a schematic view of the preferred embodiment of the present invention in a charging state. Referring to FIG. 1 and FIG. 2, the power cord 50 is first connected to a mains power socket for the power supply device 100 to have enough power for various electronic devices or electrical products. After that, when the user wants the various electronic devices or electrical products to proceed with charging, the electronic devices or electrical products can be respectively connected to the USB power socket 20 and the alternating current power sockets 40 for getting power or placed on the main body 10 to perform charging through the wireless charging module 11. Wherein, when the user wants to use the alternating current power sockets 40, the alternating current power sockets 40 can be turned to a proper position, providing a larger space for the user to connect the electronic devices or electrical products with the alternating current power sockets 40. After use, the alternating current power sockets 40 can be turned to the initial original position. Accordingly, by combining the USB power socket 20 and the alternating current power sockets 40 with the main body 10 as well as the material of the main body 10 to cooperate with the rotatable alternating current power sockets 40, the present invention saves the space and is convenient for use and carrying so as to enhance the practicability and convenience of the power supply device.

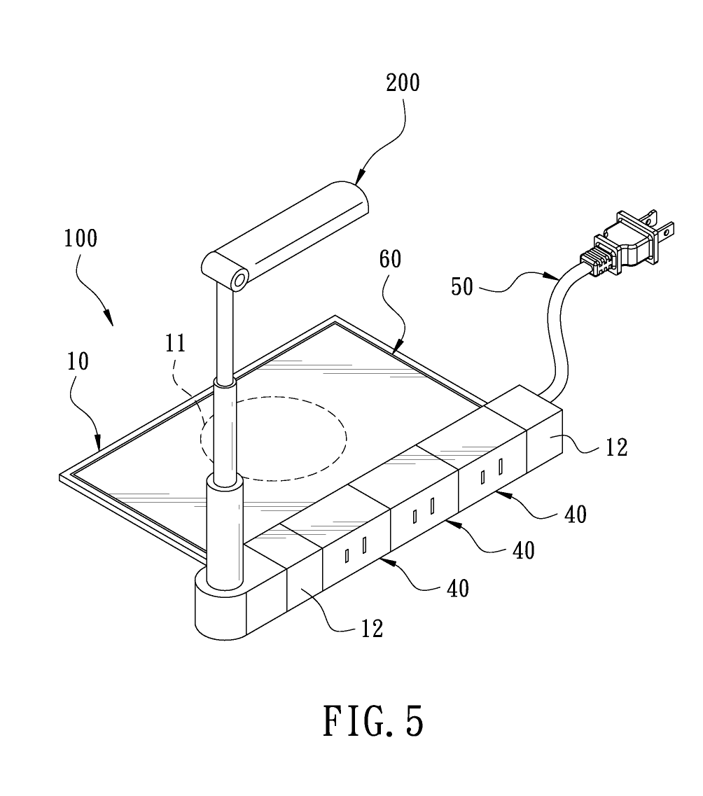

FIG. 5 is a schematic view of the preferred embodiment of the present invention connected with a table lamp. In this embodiment, the USB power socket 20 and the alternating current power sockets 40 can be selectively connected with a table lamp 200 for multiple purposes of the present invention.

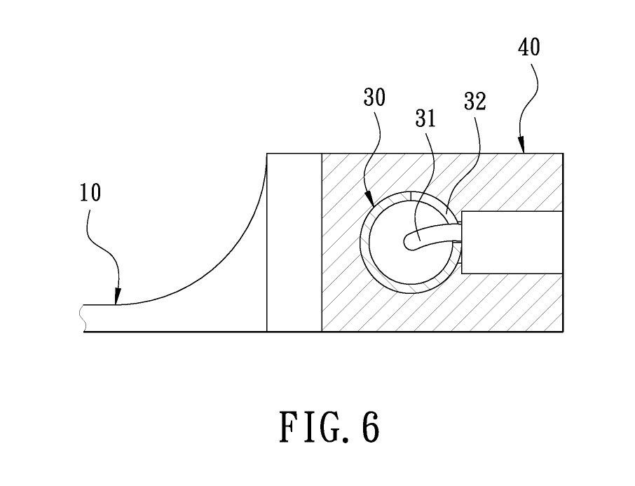

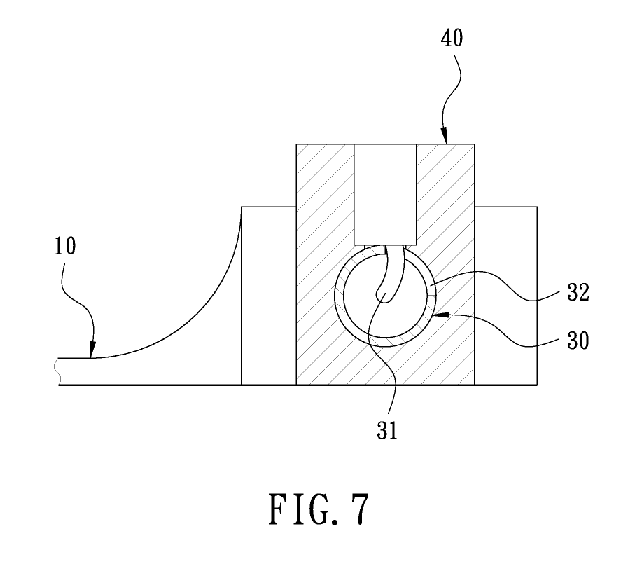

FIG. 6 is a sectional view according to the preferred embodiment of the present invention, showing that the alternating current power socket is turned to a state not in use. FIG. 7 is a sectional view according to the preferred embodiment of the present invention, showing that the alternating current power socket is turned to a state for use. The rod member 30 is formed with the plurality of holes 32 which are arranged obliquely, outward and upward, corresponding to the alternating current power sockets 40. The holes 32 each have a width about a quarter of the circumference of the rod member 30 for the electric wires 31 in the rod member 30 to extend out. The electric wires 31 are connected with the alternating current power sockets 40, respectively. The width of the holes 32 enables the alternating current power sockets 40 to bring the electric wires 31 to move when the alternating current power sockets 40 are turned, preventing the electric wires 31 from being damaged or broken because the space is not enough for movement. The present invention provides a better quality of use.

It is noted that the edges of the main body 10 are provided with LED light strips 60 for providing illumination so as to indicate the position and direction.

It is noted that the power supply device 100 capable of supplying multiple power sources is further provided with a lightning protection member to prevent a lightning strike.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A power supply device capable of supplying multiple power sources, comprising:
a main body, the main body being a thin panel, a wireless charging module being provided inside the thin panel for supplying a wireless charging power source;
at least one USB power socket disposed at one side of the main body for supplying a direct current power source;
a rod member horizontally disposed at the side of the main body;
a plurality of alternating current power sockets, the alternating current power sockets each being horizontally formed with a through hole corresponding to the rod member, enabling the alternating current power sockets to be pivotally connected with the rod member, for supplying an alternating current power source; and
a power cord connected to the side of the main body.

2. The power supply device capable of supplying multiple power sources as claimed in claim 1, wherein the main body has a rectangular shape, two ends of the side of the main body extend outward to form support arms respectively, the main body is formed with a recess defined between the two support arms, inner sides of the support arms are provided with insertion holes, and two ends of the rod member are inserted into the insertion holes of the support arms respectively, such that the rod member is located in the recess of the main body.

3. The power supply device capable of supplying multiple power sources as claimed in claim 1, wherein the rod member is a circular hollow rod member for a plurality of electric wires to be inserted therein, the rod member is formed with the plurality of holes which are arranged obliquely, outward and upward corresponding to the alternating current power sockets, the holes each have a width about a quarter of the circumference of the rod member for the electric wires in the rod member to extend out, the electric wires are connected with the alternating current power sockets respectively, and the width of the holes enables the alternating current power sockets to bring the electric wires to move when the alternating current power sockets are turned.

4. The power supply device capable of supplying multiple power sources as claimed in claim 1, wherein the main body is made of a soft material.
